(19) United States
(12) Patent Application Publication
(10) Pub. No.: US 2009/0205378 A1
(43) Pub. Date: Aug. 20, 2009

(54) WASHING APPLIANCE AND ASSOCIATED METHOD

(75) Inventor: John Helgesen, Rock Hill, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/031,870

(22) Filed: Feb. 15, 2008

(51) Int. Cl. D06F 37/26; B23P 15/00

(52) U.S. Cl. 68/3 R; 29/428

(57) ABSTRACT

A washing appliance and associated method are provided. The appliance includes a tub having a bottom wall member with forward and rearward edges. A door member has a lower edge pivotably engaged with the forward edge. A base member supports the tub and extends from about the rearward edge of the bottom wall member toward the forward edge. The base member has a forward end disposed opposite the forward edge from the lower edge of the door member, to form a toe kick recess between the lower edge and the forward end. A cover member engages the forward end of the base member, and has a flange portion extending to the forward edge of the bottom wall member, for covering the forward end of the base member and the bottom wall member about the toe kick recess, while allowing the door member to pivot to provide access to the tub.

### BACKGROUND OF THE INVENTION

1. Field of the Invention

Embodiments of the present invention relate to washing appliances and, more particularly, to a dishwasher and a method associated therewith.

2. Description of Related Art

Washing appliances, such as dishwashers, may include a wash tub for containing dishware or other items to be washed. However, the tub must also include surrounding structure and components to form an overall appliance assembly. Components of the appliance, such as the various controls, valves, and pumps, for example, are mounted outside the tub, but within the overall structure of the appliance. Accordingly, in some washing appliances, the tub is may be supported within the appliance assembly by a frame or other support structure, wherein the frame must be fastened or otherwise secured to the tub in order to maintain the appliance assembly. Many of the various operative components of the appliance may thus be mounted to the frame, under the tub, or in any suitable location. As such, the typical washing appliance may not facilitate ease of assembly of the appliance.

Some conventional washing appliances may include a front-opening door, hinged at the lower end thereof, for providing access to the interior of the tub. Such a hinged door may make it difficult to structure a frame or other support assembly for effectively enclosing the appliance, while also allowing for the pivoting configuration of the door. In such instances, a less-than-complete enclosure of the appliance, resulting open space under the door, or between the lower end of the door and the frame, may allow sound/noise generated by the operative components to “escape” from the appliance and undesirably emit noise into the environment.

Thus, there exists a need for an apparatus and method for a washing appliance for reducing the overall noise associated with the washing appliance.

### BRIEF SUMMARY OF THE INVENTION

The above and other needs are met by the present invention which, according to one aspect, provides a washing appliance, comprising a tub having a bottom wall member and defining a forward access opening, wherein the bottom wall member has a forward edge and a rearward edge. A door member has a lower edge pivotably engaged with the forward edge of the bottom wall member, and is configured to cooperate with the tub to cover the forward access opening. A base member is configured to support the tub and extends from about the rearward edge of the bottom wall member toward the forward edge thereof. The base member has a forward end disposed opposite the forward edge of the bottom wall member from the lower edge of the door member, so as to form a toe kick recess between the lower edge and the forward end. A cover member is configured to operably engage the forward end of the base member, and has a flange portion extending therefrom to the forward edge of the bottom wall member. The cover member is configured to cooperate with the base member and the bottom wall member so as to cover the forward end of the base member and the bottom wall member about the toe kick recess while allowing the door member to pivot to an open position so as to provide access to the tub through the forward access opening.

Another aspect provides a method of forming a washing appliance, wherein such a washing appliance includes a tub having a bottom wall member and defining a forward access opening, with the bottom wall member having a forward edge and a rearward edge; a door member having a lower edge pivotably engaged with the forward edge of the bottom wall member, and being configured to cooperate with the tub to cover the forward access opening; and a base member configured to support the tub and extending from about the rearward edge of the bottom wall member toward the forward edge thereof, with the base member having a forward end disposed opposite the forward edge of the bottom wall member from the lower edge of the door member, so as to form a toe kick recess between the lower edge and the forward end. Accordingly, such a method comprises engaging a cover member with the forward end of the base member such that a flange portion of the cover member extends therefrom to the forward edge of the bottom wall member, wherein the cover member is configured to cooperate with the base member and the bottom wall member so as to cover the forward end of the base member and the bottom wall member about the toe kick recess while allowing the door member to pivot to an open position so as to provide access to the tub through the forward access opening.

Thus, the various aspects of the present invention provide advantages, as otherwise detailed herein, that may include, but are not limited to: providing a washing appliance assembly including a base member and tub that are engaged with one another such that noise emissions from operative components disposed within the base member are reduced (i.e., provide a quieter appliance).

### BRIEF DESCRIPTION OF THE SEVERAL VIEWS OF THE DRAWINGS

Having thus described various embodiments of the invention in general terms, reference will now be made to the accompanying drawings, which are not necessarily drawn to scale, and wherein:

FIG. 1 is a perspective view of a base member, according to one embodiment of the present invention, configured to operably engage a tub of a washing appliance;

FIG. 2 is a partially-exploded perspective view of a washing appliance, according to one embodiment of the present invention, including a base member disposed adjacent to a tub;

FIG. 3 is a perspective view of a washing appliance, according to one embodiment of the present invention, including a tub operably engaged with a base member, wherein the tub is operably engaged with the base member such that the access opening defined by the tub is disposed toward a forward end thereof;

FIG. 4 is an exploded perspective view of a cover member configured to operably engage a base member of a washing appliance, according to one embodiment of the present invention;

FIG. 5 is a perspective rear view of a cover member, according to one embodiment of the present invention, configured to operably engage a base member of a washing appliance; and

FIG. 6 is an exploded perspective rear view of a cover member, according to one embodiment of the present invention, including an insulation element engaged with the cover member.

### DETAILED DESCRIPTION OF VARIOUS EMBODIMENTS OF THE INVENTION

Various embodiments of present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Although the various embodiments of the invention described herein are directed to a washing appliance and method, such as involving a dishwasher, it will be appreciated by one skilled in the art that the invention is not so limited. For example, aspects of the washing appliance and method of the present invention can also be incorporated into other washing appliances (such as laundry washing machines, for example). In one example, the apparatus embodiments of the present invention may comprise a “front load” laundry washing machine having a tub operably engaged with an integrally-molded base member for optimizing the space occupied by various operative components disposed therein, such that the capacity of the tub could possibly be increased. Further, such an assembly may provide “enclosure” aspects that contain the sound/noise emitted from the operative components so as to reduce the overall noise emitted from the washing appliance during operation.

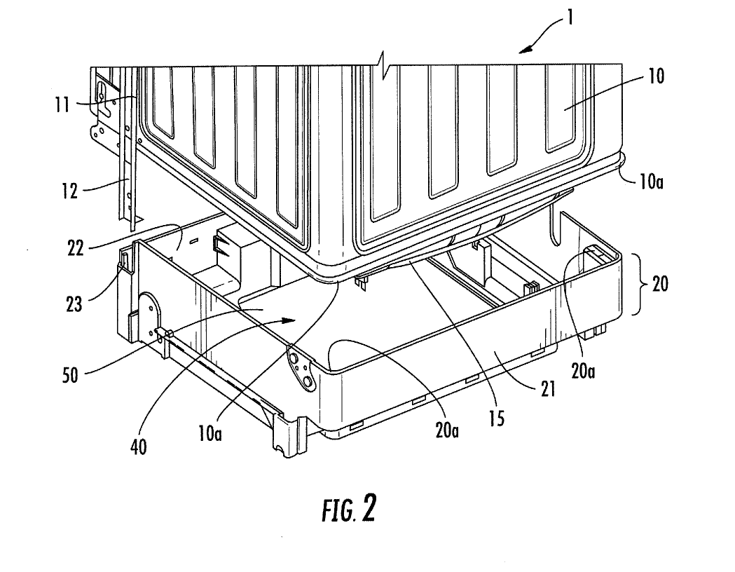

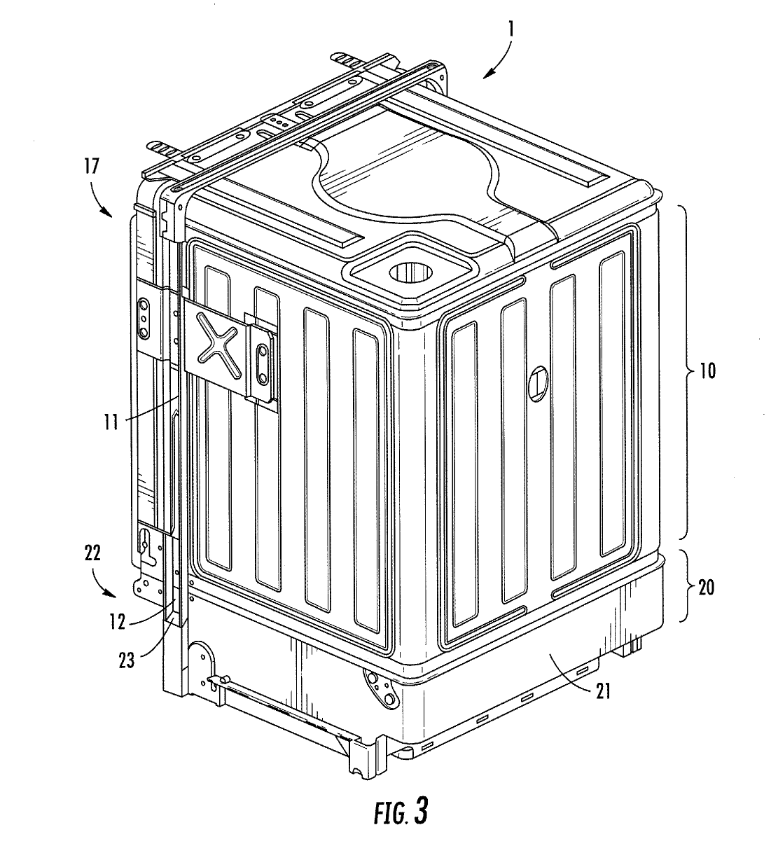

Referring to FIG. 3, one embodiment of the present invention provides a washing appliance 1, such as a dishwasher, comprising a tub 10 having a bottom wall member 15 (such as a floor and/or bottom wall member as shown in FIG. 2, for example) extending between a forward edge and a rearward edge with respect to an access opening 17 (such as a door opening, for example, of a dishwasher or laundry washing machine assembly) defined by the tub 10. The washing appliance 1 further comprises a base member 20 configured to receive and support the tub 10, wherein the base member 20 and the bottom wall member 15 of the tub 10 may include complementary engageable surfaces 10a, 20a (see FIG. 2).

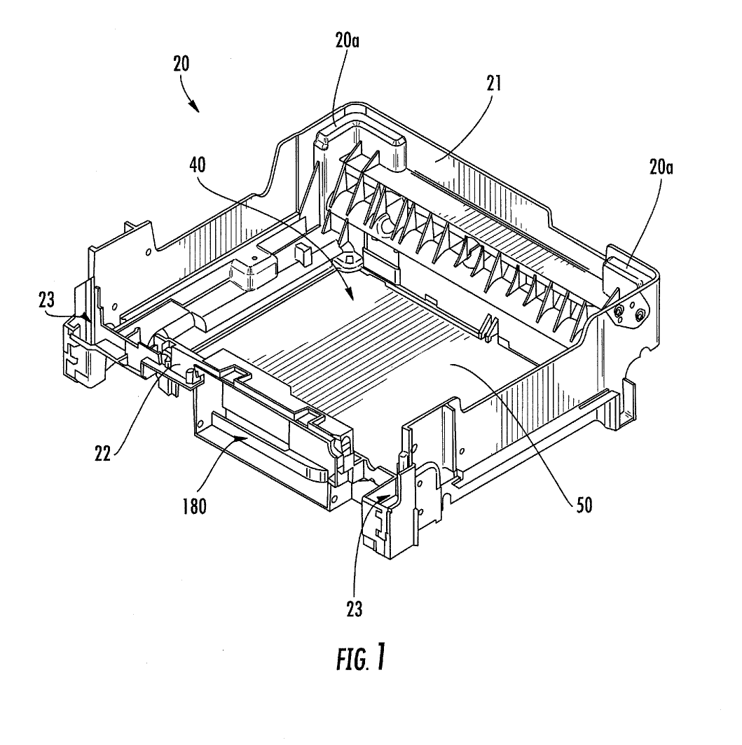

According to various washing appliance 1 embodiments, the tub 10 may be comprised of a variety of different metals, metallic alloys, polymers, and/or composite materials. For example, the tub 10 may be formed as a single integral workpiece such as, for example, a stamped metal (stainless steel, for example) tub or a molded polymer tub. Furthermore, the base member 20 may, in some washing appliance 1 embodiments, be formed as a single piece and/or integral structure (i.e., integrally-molded using materials that may include, but are not limited to: polymers and composite materials). For example, the base member 20 may be molded or otherwise constructed from a polymeric material, such as talc-filled polypropylene. In such instances, the polymeric material comprising the base member 20 may be, for example, selected to absorb or otherwise reduce the transmission of sound/noise generated by the operative components of the washing appliance 1 housed within or otherwise attached to the base member 20. As shown generally in FIGS. 1 and 2, the base member 20 may comprise one or more integrally-molded members or mounting structures that cooperate to support the tub 10 and/or a variety of operative components of the washing appliance 1 (see FIG. 3, for example).

In some embodiments, the base member 20 may define an open central portion, generally designated 40, configured to, for example, receive and support the tub 10 and/or various operative components of the washing appliance 1 such as various controls, valves and/or pumps. Thus, the molded structure of the base member 20 may not only support the tub 10, but may also provide recesses, mounting structures/surfaces, and/or mounting points for operably engaging and securing various operative components of the washing appliance 1 outside the tub 10, but within the overall structure of the washing appliance 1 (see FIG. 3, generally). In this manner, the tub 10 may be optimized in configuration to more closely correspond to the structure of the base member 20 and operative component(s) secured thereby which may, in turn, help to increase or optimize the capacity of the tub 10. As shown in FIGS. 1 and 2, the base member 20 may define one or more engageable surfaces or mounting structures 20a upon which the bottom wall member 15 (and the engageable surfaces 10a thereof) may be supported when assembling the washing appliance 1. Such surfaces 20a and/or mounting structures/points may be integrally formed (molded) with the base member 20, and the bottom wall member 15 and/or the various operative components secured thereto via one or more fasteners and/or adhesive substances.

As shown in FIGS. 1-3, the base member 20 may include a forward end 22 and a rearward end 21 (such as front and rear wall assemblies, for example). According to such embodiments, the tub 10 may be operably engaged with the base member 20 such that the access opening 17 defined in the tub 10 is oriented in the same direction as the forward end 22 (i.e., to form a forward access opening 17). Furthermore, in such embodiments, the complementary engageable surfaces 10a, 20a may be disposed substantially adjacent to the rearward end 21 of the base member 20. According to some embodiments, as shown generally in FIG. 2, the engageable surfaces 20a of the base member 20 may be configured such that a portion of the bottom wall member 15 defining the engageable surface 10a of the tub 10 may rest on and/or be supported by the engageable surface 20a of the base member 20 when the washing appliance 1 is assembled (see FIG. 3, for example).

As shown in FIGS. 2 and 3, some washing appliance 1 embodiments may further comprise a support member 11 (such as a steel support frame, for example) operably engaged with the tub 10 about the forward access opening 17 for providing additional structural support to the washing appliance 1. Furthermore, as shown in FIG. 2, a portion 12 (such as a support leg, for example) of the support member 11 may extend outwardly from the tub 10 so as to engage the tub 10 with a portion of the base member 20, such as about the forward end 22 thereof, wherein the portion of the base member 20 may comprise an integrally-molded attachment structure/point. Furthermore, in other embodiments, as shown generally in FIG. 2, the base member 20 may define one or more support apertures 23 configured to receive the portion 12 of the support member 11 extending outwardly from the tub 10. In such embodiments, the insertion of the portion 12 of the support member 11 into the complementary support aperture 23 defined in the base member 20 may provide an additional area of engagement/securement between the tub 10 and base member 20 so as to augment the connection between the tub 10 and base member 20 and facilitate the integrity of the assembly.

Referring to FIG. 1, in some embodiments, the base member 20 may be configured so as to define a compartment 180 about the forward end thereof, wherein the compartment 180 may be configured to receive a control unit or control board (not shown) implemented within the washing appliance 1 for electronically-controlling various components (i.e., circulation pump, drain pump, water valve) in furtherance of the washing process. In some instances, the base member 20 is configured such that the compartment 180 receives a housing (not shown), in which the control unit/board is disposed and mounted, wherein the housing may be pivotably mounted with respect to the compartment 180. In one instance, the compartment 180 may be further configured to isolate or otherwise protect the control unit/board from heat and/or moisture generated by the operative component(s) disposed within the base member 20 (which may be beneficial, for example, for meeting certain regulatory and/or safety standards).

In further embodiments, a catch pan member 50 may be configured to operably engage and cover the open portion of the base member 20 from about the bottom side thereof. That is, the catch pan member 50 may be disposed in opposing relationship to the bottom wall member 15 of tub 10 about the opening defined by the base member 20. In such instances, the tub 10 and/or hydraulic (water-carrying) operative components of the washing appliance 1 may be configured to engage the base member 20 such that any potential leakage point are disposed above or are otherwise configured to drain into the catch pan member 50. In this configuration, leak detection provisions may be centralized or otherwise localized to the catch pan member 50 (i.e., any leakage will be evident in the catch pan member 50), thereby facilitating a simpler and/or more reliable leak detection scheme. In other instances, the catch pan member 50 and the bottom wall member 15 may further cooperate to substantially enclose the operative component(s) disposed within the base member 20 to contain noise generated by the various operative components and reduce noise emissions from the washing appliance 1. In some embodiments, the catch pan member 50 may be removably attached to the base member 20 such that, in instances requiring service of the washing appliance 1, the catch pan member 50 may be removed to allow or otherwise facilitate access to the various operative components in the base member 20. The catch pan member 50 may be comprised of metals, metallic alloys, polymers, and/or composite materials, and, in some instances, may comprise a material capable of absorbing and/or blocking sound generated by the operative components of the washing appliance 1.

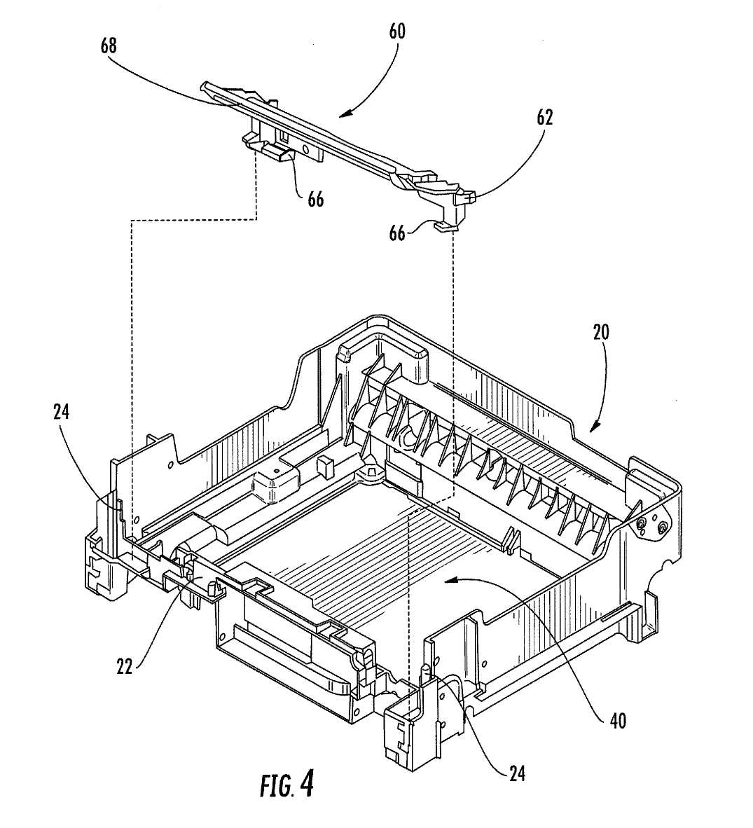

As shown in FIG. 4, some embodiments include a lower edge of a door member (not shown) pivotably engaged (i.e., hinged) with a lower end the tub 10 (i.e., the forward edge of the bottom wall member 15), such that the door member is pivotable about the lower edge thereof to provide access to the interior of the tub 10 through the forward access opening 17, and to cover and seal the forward access opening 17 when the washing appliance 1 is in operation. In such instances, the pivotable engagement between the lower end of the door member and the forward edge of the bottom wall member 15 may require particular structural provisions to allow the door member to pivot as intended to an open position, while covering and sealing the forward access opening 17 in the closed position. Further, appliances may often be configured to include a “toe kick” space for allowing the feet of a person standing in close proximity to the front side of the appliance to have an accommodation space under the front side of the appliance. Accordingly, in such instances, the forward end 22 of the base member 20 may not extend to the pivotable interface between the door member and the bottom wall member 15. That is, the forward end 22 of the base member 20 may be disposed opposite the forward edge of the bottom wall member 15 from the lower edge of the door member, so as to provide/form a toe kick recess between the forward end 22 and the lower edge of the door member. However, the toe kick recess formed in this manner may undesirably leave open or exposed portions of the base member 20, the bottom wall member 15, and/or operative components disposed thereabout.

As such, aspects of the present invention may further include a cover member 60 operably engaged with the forward end 22 of the base member 20, and having a flange portion 68 extending therefrom to the forward edge of the bottom wall member 15. In some instances, the cover member 68 is configured to cooperate with the base member 20 and the bottom wall member 15 so as to cover the forward end 22 of the base member 20, and the bottom wall member 15 about the toe kick recess, while extending across the forward edge of the bottom wall member 15 and allowing the door member to pivot to an open position so as to provide access to the tub 10 through the forward access opening 17. While the cover member 60 is disclosed herein as being a separate component from the base member 20, one skilled in the art will appreciate that, in some instances, the cover member 60 may be integrally formed with the base member 20.

In some instances, the cover member 60 may include tab portions 62 on opposing ends thereof for engaging complementary attachment mechanism structures associated with the base member 20. For example, tab portions 62 may include hook-shaped elements 64 (FIGS. 4 and 5) at the ends thereof for cooperating with projections 24 integrally-molded into the base member 20 at opposing ends proximate the forward end 22. In this manner, the complementary portions of the attachment mechanism may engage each other in a slide fit, a snap fit, or in any other suitable manner for connecting the portions of the attachment mechanism to engage the cover member 60 with the base member 20. It is envisioned, however, that other suitable configurations may be provided for engaging the cover member 60 with the base member 20. Furthermore, the cover member 60 may also include at least one foot portion 66 configured to provide supplemental engagement between the cover member 60 and the base member 20, and therefore, for example, a more robust assembly. As illustrated by the hyphenated lines in FIG. 4, each foot portion 66 may be configured to be received by a corresponding aperture or cavity, generally designated 26, defined by the base member 20. In some embodiments, the cavity 26 may be adjacent to the support aperture 23 such that foot portion 66 and portion 12 (such as a support leg, for example) are disposed substantially adjacent to one another when the washing appliance 1 is assembled.

Furthermore, as shown in FIGS. 4-6, the cover member 60 may include a flange portion 68 extending outwardly therefrom toward the forward edge of the bottom wall member 15 about the lower end of the forward access opening 17 and/or toward the lower end of the door member. As shown in FIGS. 2 and 3, in one aspect, the flange portion 68 may be configured to extend to the forward edge of the bottom wall member 15 so as to cooperate therewith to, for example, facilitate enclosure of the toe kick recess and enclosure of the operative component(s) received by the base member 20. The flange portion 68 may be further configured to extend across the forward end 22 of the base member 20 and across the forward edge of the bottom wall member 15. In this manner, the cover member 60 is configured to cooperate with the base member 20 and the bottom wall member 15 so as to cover the forward end 22 of the base member 20 and the bottom wall member 15 about the toe kick recess, while allowing the door member to pivot to an open position for providing access to the tub 10 through the forward access opening 17.

By enclosing the toe kick recess area, noise emission pathways from the appliance (of noise generated by the operative components) may be blocked, sealed, or otherwise impeded, so as to contain the noise within the appliance and provide, for example, the perception of a “quiet” or “quieter” appliance. In some instances, the flange portion 68 may be configured to cooperate with the lower end of the door member so as to not interfere with the lower end of the door member when the door member is pivoted to an open position (i.e., the door is not covering the forward access opening 17). In some embodiments, the cover member 60 may further include a sealing member (not shown) engaged with the flange portion 68 and extending therefrom to form a sealing engagement with the forward edge of the bottom wall member 15 and/or with the lower end of the door member, for example, when the door member is in a closed position (i.e., covering the forward access opening 17 into the tub 10). The sealing member may comprise, for example, a polymeric material, such as rubber, or any other material suitable for providing the sealing engagement.

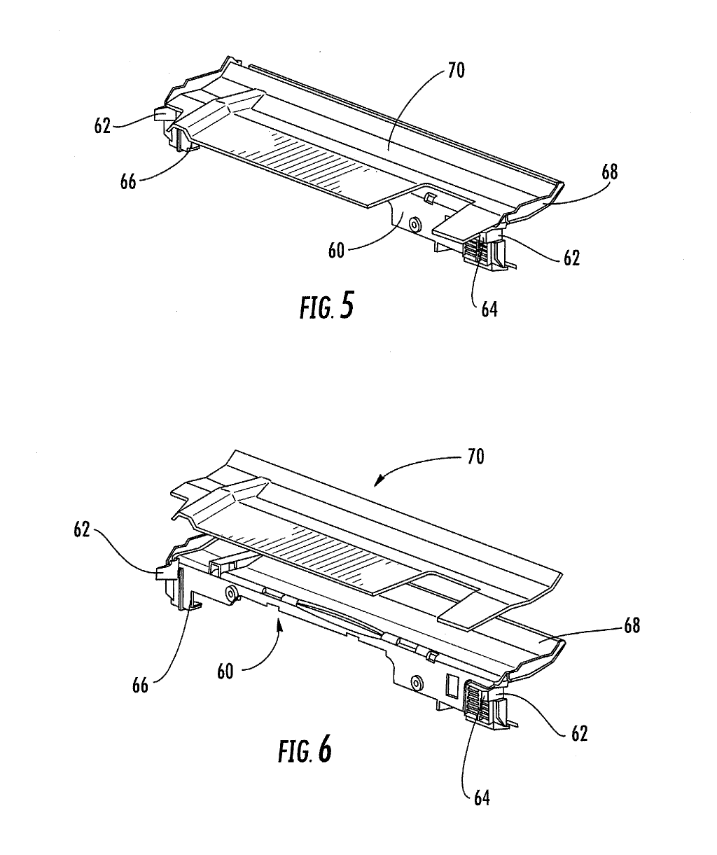

In some embodiments, as shown in FIGS. 5 and 6, an insulation element 70 may be configured to engage the cover member 60, for example, the flange portion 68 thereof, to further facilitate containment/absorption of noise generated by the operative components disposed in the base member 20, thereby reducing noise emissions from the appliance. The insulation element 70 may be configured to engage the cover member 60 so as to be disposed between the bottom wall member 15 and the flange portion 68 of the cover member 60. In some instances, the sound-reduction member 70 may be configured to conform to the flange portion 68. The insulation element 70 may be comprised of, for example, a sound-deadening material, such as an acoustic foam material, configured to absorb, block, or otherwise dampen the sound/noise generated by the operative components of the appliance disposed within the base member 20. One skilled in the art will appreciate, further, that the same or similar (or otherwise appropriate) insulation element(s) may also be applied, in some instances, to or about the base member 20 and/or the catch pan element 50 otherwise disclosed herein. In those instances, the insulation engaged with the base member 20 and/or the catch pan element 50 may serve to further absorb, block, or otherwise dampen the sound/noise generated by the operative components of the appliance disposed within the base member 20.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A washing appliance comprising:
a tub having a bottom wall member and defining a forward access opening, the bottom wall member having a forward edge and a rearward edge;
a door member having a lower edge pivotably engaged with the forward edge of the bottom wall member, and being configured to cooperate with the tub to cover the forward access opening;
a base member configured to support the tub and extending from about the rearward edge of the bottom wall member toward the forward edge thereof, the base member having a forward end disposed opposite the forward edge of the bottom wall member from the lower edge of the door member, so as to form a toe kick recess between the lower edge and the forward end; and
a cover member configured to operably engage the forward end of the base member, and having a flange portion extending therefrom to the forward edge of the bottom wall member, the cover member being configured to cooperate with the base member and the bottom wall member so as to cover the forward end of the base member and the bottom wall member about the toe kick recess while allowing the door member to pivot to an open position so as to provide access to the tub through the forward access opening.

2. A washing appliance according to claim 1, wherein the base member is comprised of a molded polymeric material and includes at least one molded mounting structure configured to receive the at least one operative component.

3. A washing appliance according to claim 1, wherein the cover member is configured to cooperate with the base member and the tub so as to substantially enclose the at least one operative component.

4. A washing appliance according to claim 1, wherein the base member and the cover member respectively define complementary portions of an attachment mechanism, the cover member thereby being securable to the base member through engagement of the complementary portions.

5. A washing appliance according to claim 1, wherein the cover member is integrally formed with the base member.

6. A washing appliance according to claim 1, further comprising an insulation element operably engaged with the cover member and cooperable therewith to contain noise generated by the at least one operative component.

7. A washing appliance according to claim 6, wherein the insulation element further comprises at least one of a sound blocking material and a sound absorbing material.

8. A washing appliance according to claim 6, wherein the insulation element further comprises an acoustic foam material.

9. A washing appliance according to claim 1, further comprising a sealing element operably engaged with the flange portion of the cover member, the sealing element being configured to interact with at least one of the bottom wall member and the door member so as to form a sealing engagement therebetween.

10. A washing appliance according to claim 1, wherein the cover member is further configured to be removable from the base member so as to allow access to the at least one operative component disposed within the base member.

11. A washing appliance according to claim 1, wherein at least one of the base member and the cover member further comprises at least one of a sound blocking material and a sound-absorbing material.

12. A method of forming a washing appliance, the washing appliance including a tub having a bottom wall member and defining a forward access opening, the bottom wall member having a forward edge and a rearward edge, a door member having a lower edge pivotably engaged with the forward edge of the bottom wall member, and being configured to cooperate with the tub to cover the forward access opening, and a base member configured to support the tub and extending from about the rearward edge of the bottom wall member toward the forward edge thereof, the base member having a forward end disposed opposite the forward edge of the bottom wall member from the lower edge of the door member, so as to form a toe kick recess between the lower edge and the forward end, the method comprising:
engaging a cover member with the forward end of the base member such that a flange portion of the cover member extends therefrom to the forward edge of the bottom wall member, the cover member being configured to cooperate with the base member and the bottom wall member so as to cover the forward end of the base member and the bottom wall member about the toe kick recess while allowing the door member to pivot to an open position so as to provide access to the tub through the forward access opening.

13. A method according to claim 12, further comprising molding the base member from a polymeric material such that the base member includes at least one molded mounting structure configured to receive at least one operative component.

14. A method according to claim 13, wherein engaging the cover member with the forward end of the base member further comprises engaging the cover member with the forward end of the base member such that the cover member cooperates with the base member and the tub to substantially enclose the at least one operative component.

15. A method according to claim 12, wherein the base member and the cover member respectively define complementary portions of an attachment mechanism, and engaging the cover member with the forward end of the base member further comprises securing the cover member to the forward end of the base member by engaging the complementary portions of the attachment mechanism.

16. A method according to claim 12, further comprising engaging an insulation element with the cover member, wherein the insulation element is cooperable with the cover member to contain noise generated by the at least one operative component.

17. A method according to claim 16, wherein engaging an insulation element with the cover member further comprises engaging an insulation element comprising at least one of a sound blocking material and a sound absorbing material with the cover member.

18. A method according to claim 16, wherein engaging an insulation element with the cover member further comprises engaging an insulation element comprising an acoustic foam material with the cover member.

19. A method according to claim 12, wherein the cover member further comprises a sealing element operably engaged with the flange portion, and engaging the cover member with the forward end of the base member further comprises engaging the cover member with the forward end of the base member such that the sealing element interacts with at least one of the bottom wall member and the door member to form a sealing engagement therebetween.
